(19) United States
(12) Patent Application Publication
(10) Pub. No.: US 2023/0399487 A1
(43) Pub. Date: Dec. 14, 2023

(54) SELF-ASSEMBLED THIN CARBON NANOTUBE FILMS USING AMPHIPHILIC PENDANT POLYMER DISPERSANTS

(71) Applicant: University of Florida Research Foundation, Inc., Gainesville, FL (US)

(72) Inventors: Andrew Gabriel Rinzler, Gainesville, FL (US); Svetlana Viktorovna Vasilyeva, Gainesville, FL (US); Maxime Gregory Lemaitre, Gainesville, FL (US); Yunxi Liu, Shenzhen (CN); Alexander Joseph Schachtner, Eugene, OR (US); Christopher Calvert Samouce, Gainesville, FL (US)

(21) Appl. No.: 18/204,602

(22) Filed: Jun. 1, 2023

Related U.S. Application Data
(60) Provisional application No. 63/350,678, filed on Jun. 9, 2022.

(51) Int. Cl. C08K 3/04; C08J 3/03; C08J 5/18

(52) U.S. Cl. CPC C08K 3/041; C08J 3/03; C08J 5/18; C08J 2301/02; C08K 2201/001

(57) ABSTRACT

Various examples are provided related to self-assembled carbon nanotube (CNT) films. In one example, a method includes providing a CNT dispersion solution including an aqueous solution comprising a quantity of amphiphilic pendant polymer dispersant; and a plurality of carbon nanotubes in the aqueous solution, the pendant polymer dispersant enabling CNT self-assembly. The method further includes forming a self-assembled CNT film on a surface of a substrate using the CNT dispersion solution.

### CROSS REFERENCE TO RELATED APPLICATIONS

This application claims priority to, and the benefit of, co-pending U.S. provisional application entitled “Self-Assembled Thin Carbon Nanotube Films Using Amphiphilic Pendant Polymer Dispersants” having Ser. No. 63/350,678, filed Jun. 9, 2022, which is hereby incorporated by reference in its entirety.

### BACKGROUND

Nanoscale materials, such as metal/metal oxide nanowires, quantum dots and carbon nanotubes (CNTs), attract significant research interest in the area of optics and electronics. Due to a fascinating combination of high electrical conductivity, unique tunable electronic properties, flexibility and transparency, percolating carbon nanotube networks (2-10 nm) and thin films (10-100 nm) have demonstrated high performance as electrodes and channel materials in a plethora of rigid and flexible electronic and optoelectronic devices such as, e.g., organic light emitting diodes (OLEDs), field effect transistors (FETs), sensors, touch screen panels and integrated circuits.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 illustrates an example of a carbon nanotube functionalized with an amphiphilic pendant polymer dispersant, in accordance with various embodiments of the present disclosure.

FIGS. 2A-2C illustrate examples of self-assembly (SA) methods, in accordance with various embodiments of the present disclosure.

FIGS. 3A and 3B are atomic force microscopy (AFM) images illustrating examples of self-assembled single walled carbon nanotube (SA SWNT) films on rigid and flexible substrates and on hydrophobic coated substrates, in accordance with various embodiments of the present disclosure.

FIGS. 4A and 4B are flow charts illustrating examples of device fabrication and film processing using SA methods, in accordance with various embodiments of the present disclosure.

FIG. 5 illustrates an example of a SA SWNT film on a resistance uniformity test substrate, in accordance with various embodiments of the present disclosure.

FIG. 6 illustrates an example of a transmittance spectrum and AFM image of a SWNT film, in accordance with various embodiments of the present disclosure.

FIGS. 7A and 7B illustrate examples of vertical field effect transistor (VFET) and vertical organic light emitting transistors (VOLET) performance using SWNT films as source electrodes, in accordance with various embodiments of the present disclosure.

### DETAILED DESCRIPTION

Disclosed herein are various examples related to self-assembled carbon nanotube (CNT) films. For example, CNT dispersion compositions, and methods of manufacturing thin carbon nanotube films by self-assembly on various substrates are presented. More specifically, carbon nanotube solutions can comprise aqueous dispersions of carbon nanotubes and a minimum quantity of amphiphilic pendant polymers. The CNT dispersion compositions can enable self-assembly of carbon nanotube films, e.g., on hydrophobic substrates.

Scalable fabrication of CNT thin film networks is important for widespread industrial implementation of CNT-based electronic devices. In principle, solution processing methods, including vacuum filtration/transfer, ultrasonic spraying, ink jet printing, dip-coating and slot-die coating, offer multiple advantages for scalability over direct growth of CNT films: lower temperature (plastic compatibility), speed and cost efficiency.

Successful solution-based deposition of uniform thin CNT films can require several important steps: 1) an efficient and stable dispersion of purified carbon nanotubes; 2) substrate functionalization to facilitate CNT adhesion; 3) uniform deposition and drying methods; and 4) in most cases, a washing step after CNT film coating to remove dispersant aids. These steps can be particularly stringent in the case of depositing very dilute, percolating CNT networks (2-10 nm films with carbon mass surface density of 142-710 ng/cm²) on slightly hydrophilic/semi-hydrophobic (e.g., most plastics, contact angles 6=70-90° and especially on hydrophobic (90-120°) substrates.

Uniform coating of low energy hydrophobic or semi-hydrophobic substrates with conducting transparent films is imperative for high performance electronic and optoelectronic devices. For example, for OLED display applications, a semiconducting layer uniformity of 5 to 15% for a high pixel-to-pixel homogeneity over the display area is demanded. Depending on the CNT coating method, the CNT solution viscosity and surface tension must be modified to be amenable with the surface energy of the substrate. Low energy substrates typically demand “surface activation”—functionalization by UV/oxygen or ozone treatment, corona discharge, and/or presence of high concentration surface wetting agents, binders and adhesion promoters—either on the substrate or in the CNT dispersion. These functionalities often change the surface properties irreversibly and/or are difficult to remove without introducing defects and non-uniformity in deposited CNT films. The activation agents can create water/oxygen redox couples or other charge traps in the vicinity of the electrode surface, which prove detrimental for electronic devices such as CNT-enabled TFTs. As such, forming uniform thin CNT film coatings on hydrophobic and semi-hydrophobic substrates remains a major challenge.

Self-assembly (SA) is a simple, fast and cost-effective method for the deposition of CNT networks, relying on interactions between CNT dispersions and the substrate. The SA method alleviates some of the most demanding rheology requirements for CNT dispersions by engineering the interactions between the carbon nanotube surface and the substrate. The Layer-by-Layer (LBL), Langmuir-Blodgett and Langmuir-Schaefer, evaporation driven dip-coating techniques have been utilized previously in attempts to form dilute CNT layers on hydrophilic substrates, but the deposited CNT coatings suffer from severe nonuniformity issues. Moreover, data on the performance of the SA-deposited CNT networks in electronic devices, scalability, and especially, data on the CNT film uniformity characterization, remain scarce. Selection of a suitable carbon nanotube dispersion formulation ensures the self-association of CNTs into homogenous films on a variety of hydrophilic and hydrophobic substrates. Therefore, CNT dispersion formulations, optimized for the scalable self-assembly methods, are highly desired.

Carbon nanotubes are bound into bundles due to strong van der Waals interactions. Typically, high power ultrasonication and/or dispersant agents are needed to de-bundle, solubilize, and stabilize the CNTs. Amphiphilic molecules are important stabilizers of dispersed systems. Commonly used CNT dispersant aids, such as ionic and non-ionic amphiphilic surfactants and small molecules (e.g., Triton-X, sodium dodecyl sulfate (SDS), cetyltrimethylammonium bromide (CTAB)), associated with the carbon nanotube surface remain in a dynamic equilibrium with the surfactant molecules in the bulk. This dynamic equilibrium necessitates high surfactant concentrations, typically on the order of the surfactants' critical micelle concentration (CMC), for CNT stabilization.

In contrast, polymer amphiphiles provide multi-point and therefore, more stable association. Importantly, amphiphilic polymers tend to self-assemble and form extended, highly organized hierarchal supramolecular structures (sheets, networks, fibers, ribbons) on air-liquid, liquid-liquid and solid-liquid interfaces. Self-assembly and rheological properties of such polymer systems are responsive to external stimuli, such as temperature, shear forces, pH, ionic strength, etc., which allows for a fast and precise property control. Among other amphiphilic polymers, water soluble, non-toxic, and biodegradable/biocompatible polyethylene glycol and polysaccharides, e.g., cellulose derivatives, starch, gelatin, chitosan, are known to effectively disperse carbon nanotubes due to non-covalent π-π interactions and entropic hydrophobic forces. Functionalization of amphiphilic polymers with pendant groups (e.g, polycyclic aromatic hydrocarbons, like pyrene, perylene etc.) that can associate with carbon nanotubes via strong van der Waals forces, provides an additional CNT association/dispersion stabilization mechanism.

In the present disclosure, solution processing, dip-coating, and Langmuir techniques can be used in a novel scalable approach to form self-assembled (SA) networks of water-soluble amphiphilic pendant polymer-functionalized carbon nanotubes (CNTs), including single walled carbon nanotubes (SWNTs), multi-walled, few-walled carbon nanotubes, and araphene. This approach allows for the fabrication of uniform thin SWNT films on a variety of flexible and rigid substrates. The homogenous SA SWNT films can be formed on hydrophilic, slightly hydrophobic and the most challenging low energy, highly hydrophobic substrates useful for various electronic and optoelectronic applications. The applications include but are not limited to thin film transistors (TFTs), vertical field effect transistors (VFETs), vertical organic light emitting transistors (VOLETs), organic light-emitting diode (OLED) and quantum-dot (QD) based displays, circuit boards and touch-screen panels in cellphone and automotive displays.

Various examples related to the carbon nanotube (CNT) solution compositions comprised of aqueous dispersions of carbon nanotubes and amphiphilic pendant polymers will now be disclosed. The CNT dispersion compositions can enable self-assembly of CNTs on a broad range of rigid and flexible hydrophobic and hydrophilic substrates. These self-assembly (SA) methods allow for scalable fabrication of uniform, percolating CNT networks and thin CNT films on a broad range of hydrophilic and more challenging low-energy, hydrophobic substrates, useful for various electronic applications, including but not limited to VFETs, VOLETs, OLEDs, QD based displays and automotive touch screen displays. Reference will now be made in detail to the description of the embodiments as illustrated in the drawings, wherein like reference numbers indicate like parts throughout the several views.

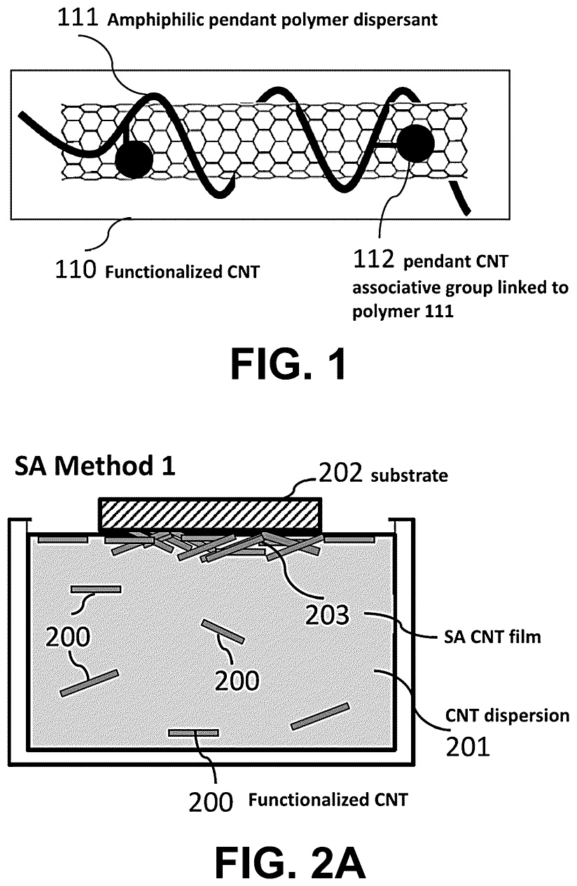

Referring to FIG. 1, shown is an example of a carbon nanotube functionalized with an amphiphilic pendant polymer dispersant. The example of FIG. 1 is directed to a functionalized CNT 110 dispersion composition, comprising a water-soluble amphiphilic polymer backbone 111, which can be linked to a multitude of pendant groups 112 that can associate with a carbon nanotube or graphene surface by non-covalent van der Waals interactions, and which preserve the intrinsic properties of CNTs. The amphiphilic polymer backbone 111 can also contain at least two pendant end groups. The pendant group 112 can comprise a polycyclic aromatic group, such as pyrene, parylene, anthracene, porphyrine, etc. The amphiphilic polymer backbone 111 can comprise a water soluble amphiphilic homopolymer or block-copolymer, that possess an affinity for the carbon nanotube surface due to hydrophobic and π-interactions. Examples of amphipilic homopolymers include but are not limited to biocompatible/biodegradable non-toxic polysaccharides, such as cellulose derivatives, e.g., hydroxypropyl cellulose (HPC), hydroxypropylmethyl cellulose (HPMC), hydroxyethyl cellulose (HEC) and ethyl hydroxyethyl cellulose (EHEC), carboxymethyl cellulose (CMC), starch, chitosan, gelatin; polymer ethers like polyethylene glycol (PEG). The amphiphilic polymer backbone has a molecular weight in the range of 15,000-100,000 Daltons (Da) to possess sufficient hydrophobicity. Block-copolymer backbones include at least one long hydrophobic building block, such as Pluronic triblock copolymer series (e.g., PEOₓ-PPO_{y}-PEOₓ, y>50).

Another example is directed to an aqueous amphiphilic pendant polymer-based carbon nanotube dispersion, containing a minimum quantity of dispersant. Excess dispersant can be removed from the CNT dispersion solution by dialysis, microfiltration, filtration/washing or centrifugation/washing/decanting cycles until the non-associated, CNT-free polymer concentration in solution is <10 μg/ml and preferably <1 μg/ml. Removal of polymer excess is important for the CNT thin film formation on the substrate to avoid preferential self-association of CNT-free polymer dispersant on the substrate, blocking the association of the CNT associated dispersant. This can also ensure ease of polymer residue elimination and/or removal after the CNT film is fabricated without introducing defects and non-uniformity, After the film is dried, the polymer dispersant residue can be cleaned by washing the CNT film on the substrate in water and/or common organic solvents, such as alcohols, acetone, mildly acidic or basic aqueous solutions, or by light irradiation, etc, Once the polymer dispersant residue is removed, the CNT film electrical conductivity and optical transmittance are increased.

An example can be directed to the self-assembly methods of forming thin and uniform carbon nanotube films on a variety of rigid and flexible substrates. The multitude of substrates include hydrophilic (θ=0-90°) and low-energy hydrophobic substrates (θ=90-120°. Examples of hydrophilic substrates include, but are not limited to, glass, metal, and metal oxides. Semi-hydrophobic or slightly hydrophilic substrates (θ=70-90°) include, but not limited to, plastics like PET, PVC, PVDF, polyimide, hydrophobized glass and Si/SiOₓ. Examples of the most challenging low-energy hydrophobic substrates include, but are not limited to, fluorinated polymers, such as PTFE, PFA, ETFE, Teflon-AF, Hyflon, Cytop; hydrophobic non-fluorinated polymers; fluorinated silanes; polysiloxanes (PDMS).

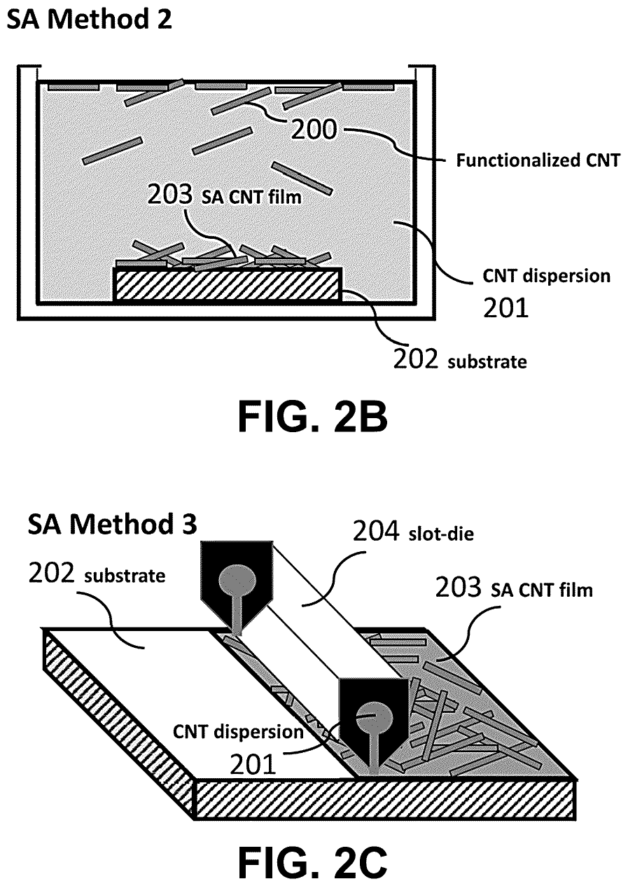

Another example can be directed to methods of fabricating thin CNT films as illustrated in FIGS. 2A-2C, using self-assembly of amphiphilic pendant polymer-functionalized CNTs into extended networks at air-liquid and solid-liquid interfaces. FIG. 2A schematically illustrates a first SA method (inverted SA), which includes a polymer-assisted CNT network formation at the air-liquid interface. The CNTs self-associate at the air-liquid interface into a thin film layer. The functionalized CNTs 200 are driven to the air-liquid interface of the CNT dispersion 201 by diffusion, forming an extended self-assembled layer. The self-assembly can be accelerated by agitation and/or by heating the dispersion to a temperature higher than the lower critical solution temperature (LOST) of the dispersant polymer. The thermo-responsive amphiphilic pendant polymers self-aggregate into complex structures upon heating. The CNT dispersion agitation induces mixing flows that can bring the polymer associated CNTs to the air-liquid interface.

The pre-formed self-associated CNT network can then be picked-up from the interface using an inverted hydrophilic or hydrophobic substrate 202, allowing for deposition of the uniform thin SA CNT film 203. When the substrate 202 is placed face down onto the pre-formed thin homogenous CNT film at the air-liquid interface the functionalized CNTs adhere to the substrate surface. If an ordered directional CNT film formation is needed for a specific application, the CNT network pre-formed at the air-CNT dispersion interface could be compressed in a certain direction using a Langmuir trough.

FIG. 2B schematically illustrates a second SA method (immersive SA) that comprises coating and/or immersing the substrate into the bulk CNT dispersion 201 and allowing for a brief (10 s-10 min) or extended (30 min-2 h) CNT self-association at the solid/liquid interface on the substrate 202. The substrate is immersed into the functionalized CNT dispersion bath and the CNTs self-associate directly at the solid-liquid interface to form a film on the substrate. A brief rinse in water can remove non-associated CNT dispersion, and the film 203 can be dried by hot air or on a hot plate at 50-75° C. The coating steps are repeated for a desired CNT film density.

FIG. 2C schematically illustrates a third SA method comprising the polymer-based CNT dispersion 201 coated onto the substrate 202 by, e.g., a Mayer rod coater or slot-die coater 204. The SA film is formed when the functionalized CNT dispersion is coated across the substrate by the slot-die, rod- or blade-coater, Shear forces tend to disrupt hydrophobic and hydrogen bonding interactions, which is why multiple coatings and control (or optimization) of the deposition rate is needed to achieve the desired coating. After each coating step, the deposited layer 203 on the substrate 202 can be briefly rinsed with water and dried by hot air or on the heated coating platform.

One feature of the first SA method is the preliminary self-assembly of the CNTs into a thin-film layer at the air-liquid interface of the CNT dispersion. Then the pre-formed CNT film can adhere to the substrate surface by contact. Self-assembly at the air-liquid interface and in the bulk of solution occurs predominantly via hydrophobic interactions between hydrophobic segments, building blocks or functionalities of the amphiphilic polymer backbone. Self-assembly can be assisted by hydrogen bonding between hydrophilic segments or polar functional groups of the amphiphilic polymer backbone.

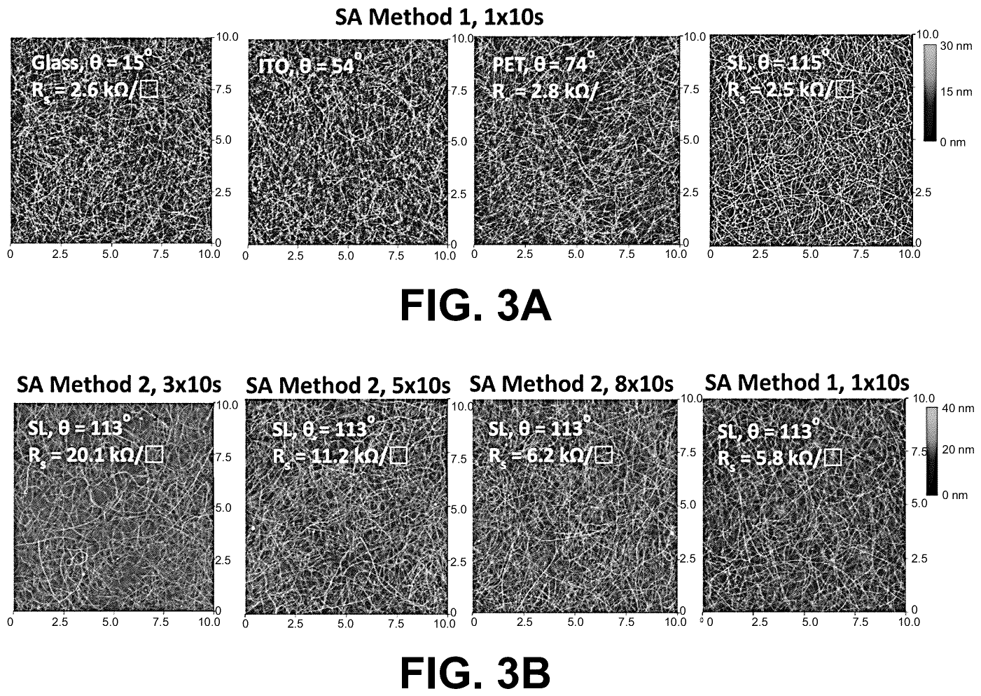

FIG. 3A shows 10 μm×10 μm AFM images of self-assembled SWNT films on a series of rigid and flexible substrates, having different surface energy and/or hydrophobicity: glass, ITO, PET and low energy hydrophobic substrate (SL). The SA SWNT films were prepared using the first SA method and show similar density and conductivity (sheet resistance (R s)) on all tested substrates independent of their surface energy/hydrophobicity, which makes the first SA Method universal for a wide range of rigid and flexible substrates.

In the three SA methods, the carbon nanotube film density could be reliably controlled by the functionalized CNT concentration in the dispersion, coating time and/or by the number of coating steps. For example, the functionalized CNT dispersions can be diluted to a concentration needed to deposit a single layer CNT film of the desired CNT density (so called “single-use” dispersions). After a single-layer or multilayer CNT film deposition using one of the three SA methods is complete, and the layer dried on the substrate surface, the formed coating can be soaked in water, common organic solvents such as alcohols, acetone, or mild acidic or basic aqueous solutions to remove the minimal polymer dispersant residue.

Uniformity of the SA-formed CNT films is a prerequisite to achieve high performance electronic and optoelectronic devices. The uniformity of the self-assembled SWNT films can be visualized by making multi-point AFM images of different areas of the film. FIG. 3B shows 10 μm×10 μm AFM images of the self-assembled CNT films of different densities on low energy hydrophobic substrates (SLs). The CNT films were prepared using the first and second SA methods. In this example, the film density was controlled by the number of coating steps. The images compare the density and/or sheet resistance of the SWNT films deposited on the LS hydrophobic coated substrates by the first and second SA methods. The second SA method needed multiple immersion/drying steps (e.g., eight 10 s dips followed by drying steps) to achieve similar SWNT density to that of the film deposited using the first SA method (involving a single 10 s dip of the substrate across the air/water interface).

As self-assembly in the bulk of solution (the second SA method) occurs predominantly via hydrophobic forces, the CNTs association with hydrophobic and semi-hydrophobic substrates is quite fast (10 s-30 min coating step, depending on the solution CNT concentration and the desired film density). The association of the CNTs with hydrophilic substrates (e.g., metal/metal oxides, glass) in this case has been observed to proceed more slowly, needing longer times (60 s-2 h, depending on the desired film density). Thus, the second SA method can be used for a selective CNT deposition on predominantly hydrophobic substrates, when deposition is allowed to proceed in a short coating time regime. The second SA method can be utilized for the CNT deposition simultaneously on both hydrophobic and hydrophilic substrates in a longer time regime. The CNT self-assembly on hydrophilic substrates can be facilitated by substrate treatment with adhesion promoters or hydrophobizing agents such as, e.g., aminopropyltriethoxysilane (APTES), fluorinated silanes, and/or fluorinated surfactants. The ability to control the self-assembly on different energy substrates is important for patterning processes of different electronic and optoelectronic device structures and/or architectures.

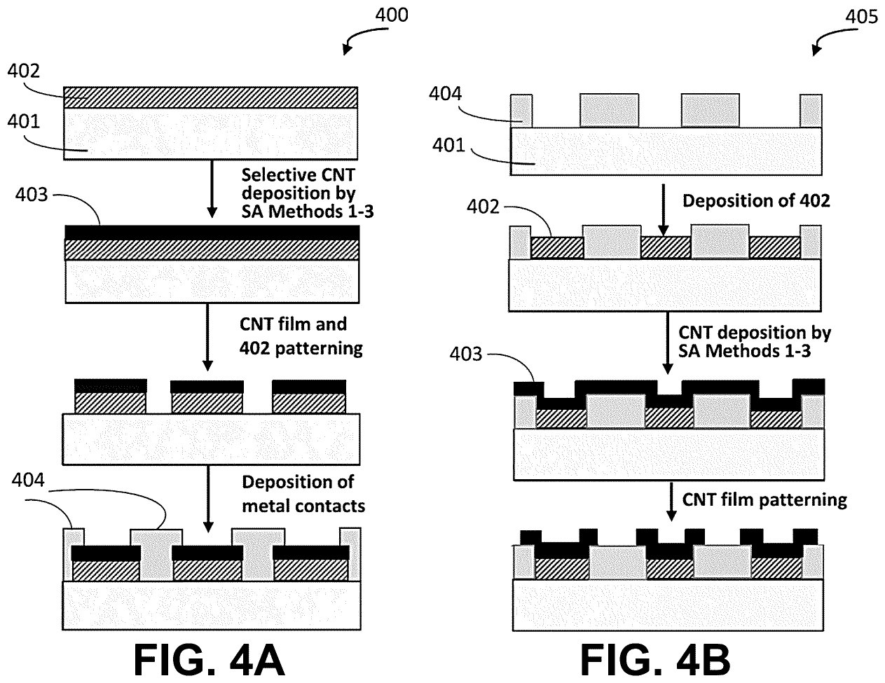

The uniformity of the self-assembled SWNT films can be evaluated by taking a series of AFM images of the film. Another method to assess homogeneity of the self-assembled SWNT films, is to deposit SWNTs onto so called resistance uniformity test devices in either a top-contact configuration 400 as illustrated in FIG. 4A or a bottom contact device configuration 405 as illustrated in FIG. 4B. The resistance uniformity test substrate can comprise a low surface energy hydrophobic layer 402 (SL, θ=110-120°) on a rigid or flexible substrate 401 and an array of metal electrodes pairs 404. After the CNT film 403 deposition and washing excess dispersant in a 65° C. hot ethanol bath, the SA SWNT film can be patterned as strips (pixels) extending across each electrode pair. The resistances across the pixels can then be measured. As shown in FIGS. 4A and 4B, the SA methods can be used for either simultaneous or selective CNT deposition onto hydrophobic SL substrate and/or hydrophilic metal contacts in the “bottom contact” and “top contact” configurations of the resistance uniformity test devices (405 and 400 respectively).

FIG. 4A illustrates the CNT deposition onto a hydrophobic surface layer, using the three SA methods, with a subsequent deposition of the metal contacts (top-contact device configuration) such as, e.g., hydrophilic metal contacts. A selective CNT deposition onto the hydrophobic surface, using the second SA method, can be performed by dip-coating the substrate in a series of short (10 s-30 min, depending on desired film density) coating steps. FIG. 4B illustrates the bottom-contact uniformity test structure using the three SA methods (universal CNT deposition onto both hydrophobic SL and hydrophilic metal contacts in a “bottom-contact” device configuration). The second SA method can be used to deposit on both hydrophobic SL and hydrophilic metal contacts by longer (60 s-2 h) coating step or after the substrate is treated with adhesion promoters/agents to facilitate self-assembly on hydrophilic metal contacts.

The metal contacts 404 can first be deposited onto the substrate with subsequent deposition of the hydrophobic layer 402. The CNT film can then be self-assembled simultaneously on hydrophobic layer and hydrophilic metal contacts, e.g., using the three SA methods. For a successful CNT film deposition, using the second SA method, the coating process should be sufficiently long (60 s-2 h, depending on the desired film density) or the substrate can be treated with the adhesion promoters and/or hydrophobizing agents to facilitate self-assembly on hydrophilic metal contacts.

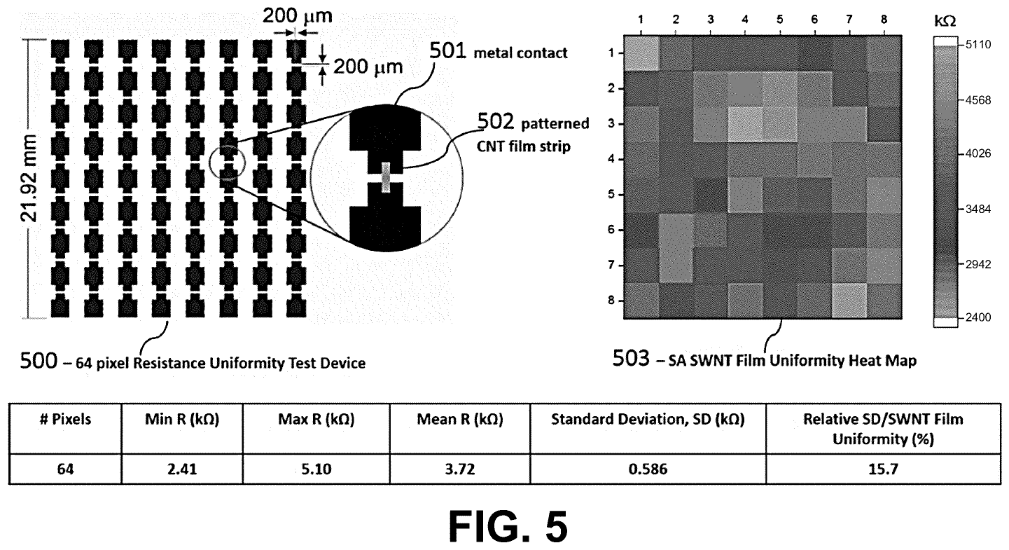

Referring to FIG. 5, shown is a schematic of the resistance uniformity test device 500 for the SA CNT film homogeneity evaluation. The SA SWNT film was deposited on the resistance uniformity test substrate using the first SA method, 1×10 s coating step, C_{SWNTs}=4.5 μg/mL in the pyrene-functionalized hydroxypropylcellulose (Py-HPC) CNT dispersion. The free Py-HPC dispersion concentration measured by fluorescent spectroscopy was very low ˜0.3 μg/m L. The minimal polymer dispersant concentration resulted in an efficient CNT self-assembly. The SWNT film is self-assembled on the low energy hydrophobic substrate SL (θ=110°) without use of any adhesion promoter. After the film deposition and removal of excess dispersant in a 65° C. hot ethanol bath, the SA SWNT film was patterned as 200 μm wide strips 502 (pixels) extending across each electrode pair 501 (64 pixels) as indicated in in the magnified region in FIG. 5. The resistances across the 200 μm×200 μm pixels were then measured. The resistance distribution graph 503 (uniformity heat map) and statistics results for the SWNT film show a reasonable uniformity, ranging from 2.4 to 5.1 kΩ/□ (kOhm/square). The mean value is 3.7 kΩ/□ with a standard deviation of 0.586 kΩ/□ (15.7% of the mean). Such SWNT film uniformity is highly promising for high performance electronic devices.

Recently, a fundamentally new CNT-enabled transistor architecture has been introduced, that promises to greatly lower active-matrix light-emitting diode (AMOLED) display manufacturing costs by dramatically reducing the backplane circuit complexity. At minimum, the conventional active-matrix backplane circuit needed to independently light each pixel of an AMOLED display utilizes a switching transistor, a drive transistor, and a capacitor in the so called 2T+1C circuit. The drive TFT must be able to source large and stable on-state currents at reasonable drive voltages. This requires that the TFT have a very low on-state channel resistance, which can be achieved in one of two ways: (1) employing a relatively high-mobility semiconductor, or with (2) a short channel length. The first option limits the choice of channel semiconductors to a handful of inorganic materials (IGZO and LTPS) which are difficult to process on large substrate sizes. The second option—in the conventional TFT architecture—is limited by the patterning resolution used to define the source-to-drain spacing.

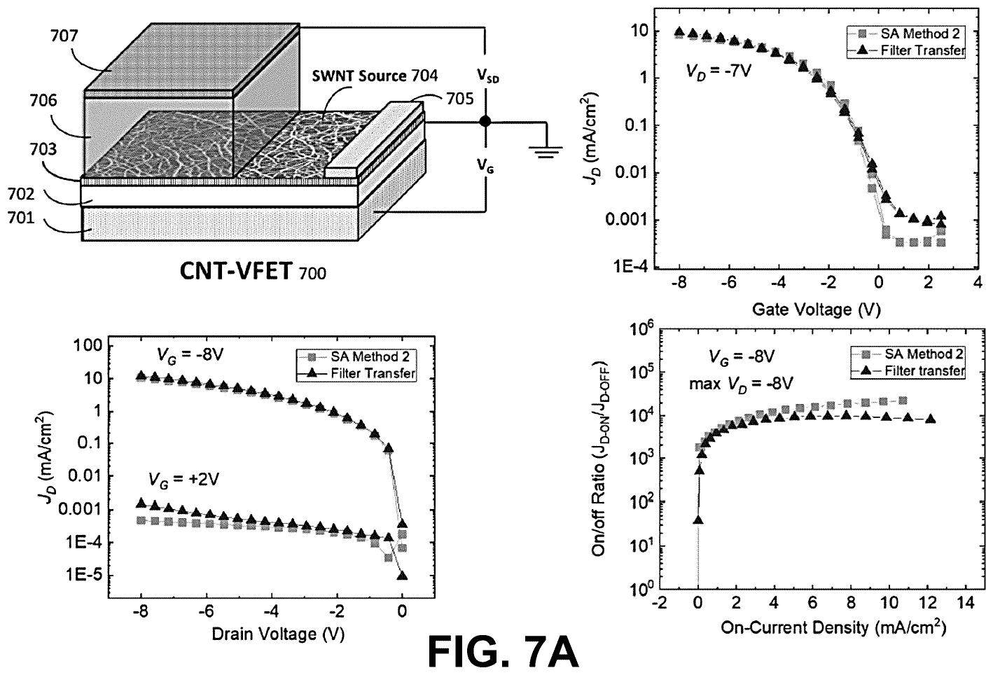

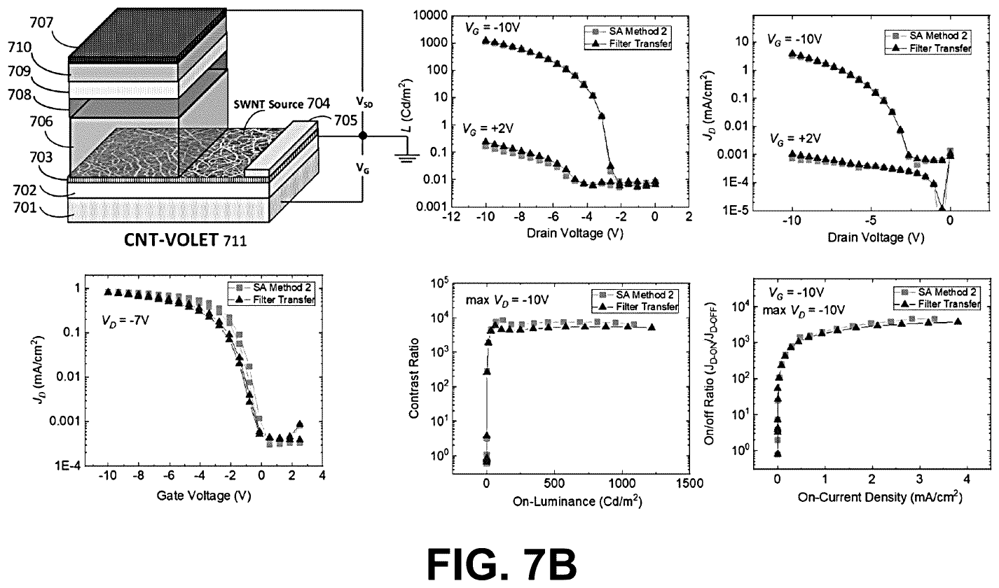

FIGS. 7A and 7B illustrate performance of vertical field effect transistor (VFET) and vertical organic light emitting transistor (VOLET) devices, using SWNT films as source electrodes. Percolating SWNT films were deposited by the second SA method and by a vacuum filtration/transfer method (control). The schematics of the CNT-enabled vertical field effect transistor (CNT-VFET) 700 and vertical organic light emitting transistor (CNT-VOLET) 711 devices are shown in FIGS. 7A and 7B, respectively. In this device architecture, the current flow is reoriented from the horizontal to the vertical. The devices represent stacked structures, including a gate electrode 701, a dielectric layer 702, a low energy hydrophobic surface layer 703, which reduces number of water/oxygen charge traps at the electrode surface and thus improves the device stability.

A dilute, transparent carbon nanotube film is a device component and acts as a planar source electrode 704 with a contact 705, on which in the VFET device the semiconductor 706 and drain 707 are stacked. The gate field modulates the charge injection barrier at the interface of the CNT film and the semiconducting channel. In a VOLET device a hole transport layer 708, an emissive layer 709 and an electron transport layer 710 (the organic light emitting diode components) can be added between the channel layer and the drain electrode. As proof of principle, the SWNT films used in these devices were prepared by a vacuum filtration/transfer method. The vacuum filtration/transfer method produces highly uniform SWNT films with a precise film density control but is hardly scalable. Self-assembly deposition methods described in this disclosure can provide a scalable alternative for the uniform thin CNT film deposition.

Performance of the CNT-VOLETs rely on the high electrical conductivity and optical transmittance of the CNT films. In these devices the magnitude of the source-drain current is dictated by the gate-modulated charge injection barrier at the interface between the CNT film and the organic semiconductor (OSC). The SWNT film should be sufficiently dilute (CNT film with carbon mass surface densities of 150-1000 ng/cm²) to allow the gate-field access to the CNT-OSC interface (through the naturally occurring pores in the CNT film) to electrostatically control the height and width of the injection barrier.

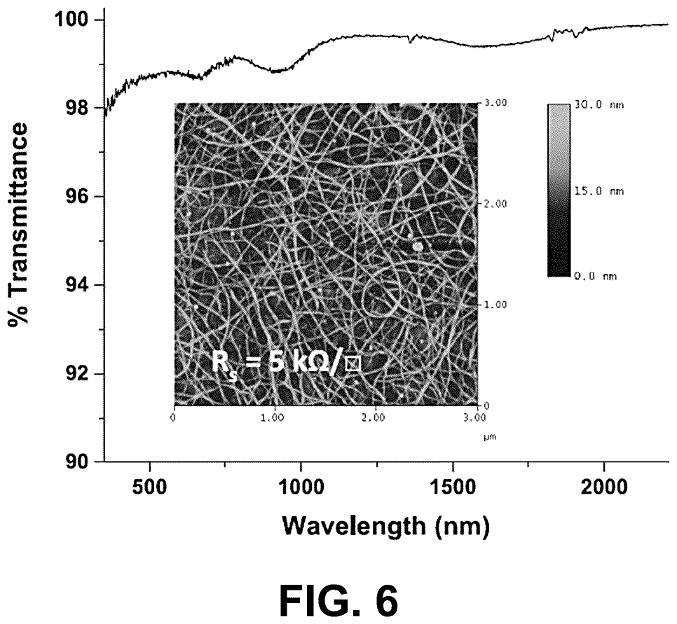

FIG. 6 shows the UV-Vis/NIR transmittance spectrum and the AFM image (3 μm×3 μm) of the representative dilute SWNT film (density of about 500 ng/cm²), prepared by the first SA method on a hydrophobic substrate (θ=110°)(4×10 s coating steps, % T=98.8%, Rs=5.7 kΩ/□). The typical AFM image shows a good homogeneity of the SWNT film. The dilute, uniform SA SWNT film demonstrates a high transmittance T_{550 nm}=98.8% and a low sheet resistance Rs=5.7 kΩ/□. These sheet resistance/transmittance values are comparable or exceed the corresponding parameters of the state-of-the-art solution processed SWNT films deposited on higher surface energy, less challenging substrates.

The JLV graphs in FIGS. 7A and 7B show a comparable performance of the VFETs and VOLETs, using the SWNT films deposited by the second SA method and by the “control” vacuum filtration/transfer method. The self-assembled SWNT film-based VFET devices demonstrated slightly higher drain currents and on/off ratio compared to that of the “control” device, using the SWNT source electrode prepared by the vacuum filtration/transfer method. The SA film-based VOLET devices slightly outperformed the control device, showing higher luminance and contrast ratio. Hence, the self-assembly SWNT film deposition methods disclosed here can serve as a scalable method of SWNT film formation for such devices.

The disclosed methodology allows for the fabrication of highly uniform, dilute, percolating CNT networks and thin CNT films onto low energy substrates by facile, scalable self-assembly methods that do not require substrate surface functionalization or CNT dispersion rheology adjustment. This can facilitate widespread CNT film-based device implementation in the area of optics and electronic, including OLED displays, touch screen panels, TFTs, FETs and sensor industries.

### Example

An example of the present disclosure is directed to the amphiphilic pendant polymer CNT dispersion formulation comprising aqueous dispersion of SWNTs and pyrene-substituted hydroxypropylcellulose (Py-HPC, 1 pyrene functional group per 130 polymer repeat units, Mw=60,000 Da). Although Py-HPC is a known CNT dispersant, no self-assembly CNT film deposition using Py-HPC-based CNT dispersions has been reported. Minimization of the excess Py-HPC polymer in the dispersion is one of the factors enabling SWNTs self-assembly on the substrates. Excess dispersant polymer results in a preferential polymer deposition on the substrate. The functionalization of HPC with Py-groups allowed for the additional CNT association (via Py-CNT sidewall pi-stacking) and thus for the utilization of much lower Py-HPC concentrations to obtain stable CNT dispersions. First, a (1:1 weight ratio) PyHPC: SWNT solution (C_{py-HPC}=0.001-0.0014 wt % or 10-15 μg/ml) was prepared and then the non-associated, CNT-free polymer excess was removed by dialysis until the Py-HPC concentration reached <0.3 μg/ml. No SWNT flocculation was observed in the dialyzed Py-HPC/SWNT dispersions for over a year. Such minimum excess SWNT dispersion enabled carbon nanotube self-assembly and the uniform SWNT thin film formation preferentially on hydrophobic substrates, which is advantageous for various electronic applications.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about y”.

Therefore, at least the following is claimed:

1. A method, comprising:
providing a carbon nanotube (CNT) dispersion solution comprising:
an aqueous solution comprising a quantity of amphiphilic pendant polymer dispersant; and
a plurality of carbon nanotubes in the aqueous solution, the pendant polymer dispersant enabling CNT self-assembly; and
forming a self-assembled CNT film on a surface of a substrate using the CNT dispersion solution.

2. The method of claim 1, wherein the amphiphilic pendant polymer dispersant comprises a water-soluble polysaccharide backbone substituted with at least one CNT interacting pendant group.

3. The method of claim 2, wherein the at least one CNT interacting pendant group comprises a polycyclic aromatic group.

4. The method of claim 1, wherein the amphiphilic pendant polymer dispersant is pyrene-labeled hydroxypropyl cellulose.

5. The method of claim 1, wherein the plurality of carbon nanotubes are single-walled carbon nanotubes (SWNTs), few-walled carbon nanotubes, multi-walled carbon nanotubes, or a combination thereof.

6. The method of claim 5, wherein a concentration of carbon nanotubes is in a range from about 1 μg/ml to about 25 μg/ml.

7. The method of claim 1, wherein the substrate is a rigid substrate or a flexible substrate.

8. The method of claim 1, wherein the substrate comprises a hydrophilic surface, a semi-hydrophobic surface or a low energy hydrophobic surface.

9. The method of claim 1, wherein the substrate is a hydrophilic substrate, and the surface is treated with a hydrophobic agent, a wetting agent or an adhesion promoter.

10. The method of claim 1, wherein the substrate is a low energy substrate of an electronic or optoelectronic device.

11. The method of claim 10, wherein the electronic or optoelectronic device is a vertical field effect transistor (VFET) device or a vertical organic light emitting transistor (VOLET) device.

12. The method of claim 1, wherein the self-assembled CNT film is formed on the surface of the substrate by one or more coatings using the CNT dispersion solution.

13. The method of claim 12, wherein excess amphiphilic pendant polymer dispersant is removed from the CNT dispersion solution by dialysis, microfiltration, filtration/washing, heating above the lower critical solution concentration (LCSC)/precipitation/centrifugation cycles, or centrifugation/washing/decanting cycles until a non-associated, CNT-free polymer concentration in solution is less than 10 μg/ml.

14. The method of claim 1, wherein the plurality of carbon nanotubes forms a self-assembled (SA) layer at an air/liquid interface of the CNT dispersion solution, and the SA layer adheres to a hydrophilic surface, a semi-hydrophobic surface or a low energy hydrophobic surface of the substrate.

15. The method of claim 14, wherein the substrate is coated with a SWNT film density from the CNT dispersion solution comprising single-walled carbon nanotubes (SWNTs) of a concentration less than 1 μg/mL.

16. The method of claim 1, comprising coating or immersing the substrate in the CNT dispersion solution and allowing CNT self-association at a solid/liquid interface of the substrate.

17. The method of claim 16, wherein the substrate is a hydrophobic or semi-hydrophobic substrate that is coated or immersed in the CNT dispersion solution for seconds to 30 minutes.

18. The method of claim 16, wherein the substrate is a hydrophilic, semi-hydrophobic or hydrophobic substrate that is coated or immersed in the CNT dispersion solution for 60 seconds to 2 hours.

19. The method of claim 1, wherein the CNT dispersion solution is coated onto the surface of the substrate by a Mayer rod coater or a slot-die coater.

20. The method of claim 1, wherein the CNT self-assembly is accelerated by heating the CNT dispersion solution to a temperature below a lower critical solution temperature (LOST) and cooling down to 5-25° C.

21. The method of claim 1, wherein the self-assembled CNT film is a percolating CNT film with a carbon mass surface density in a range from about 150 ng/cm² to about 1000 ng/cm².

22. The method of claim 1, wherein the self-assembled CNT film is formed with the CNT dispersion solution having a single-walled carbon nanotube (SWNT) concentration between about 1 μg/mL to about 12 μg/mL.

23. The method of claim 1, wherein polymer dispersant residue is removed by washing the CNT film in water, organic solvents, alcohols, acetone, or mildly acidic or basic aqueous solutions, or by light irradiation.

24. The method of claim 1, wherein the CNT film comprises a highly uniform, electrically conductive thin film comprising a plurality of single walled carbon nanotubes with a light transmittance of at least 95% at 550 nm and a sheet resistance between about 1 kΩ/□ to about 30 kΩ/□ is formed.
